(19) United States
(12) Patent Application Publication
(10) Pub. No.: US 2010/0036971 A1
(43) Pub. Date: Feb. 11, 2010

(54) PROCESSING UNIT AND PORTABLE ELECTRICAL DEVICE AND AUTO-RUN METHOD THEREOF

(76) Inventors: Hsiang-chi Hsieh, Sindian City (TW); Chi-hung Chiang, Tucheng City (TW); Hung-lin Liu, Jhonghe City (TW); Chiun-wu Chang, Taipei City (TW)

Correspondence Address: AUSTIN RAPP & HARDMAN, 170 South Main Street, Suite 735, SALT LAKE CITY, UT, 84101, US

(21) Appl. No.: 12/430,257

(22) Filed: Apr. 27, 2009

(30) Foreign Application Priority Data
Aug. 8, 2008 (TW) 097130443

(51) Int. Cl. G06F 3/00; G06F 15/177

(52) U.S. Cl. 710/10; 713/2

(57) ABSTRACT

A processing unit, a portable electrical device and an auto-run method thereof are described. The processing unit of the portable electrical device has a kernel program memory area where a virtual memory device is established. Then, a virtual auto-run file is stored in the virtual memory device. When the portable electrical device is electrically connected to an electronic apparatus, the electronic apparatus automatically executes at least one predetermined operation on the portable electrical device according to the virtual auto-run file.

### CLAIM OF PRIORITY

This application claims priority to Taiwanese Patent Application No. 097130443 filed on Aug. 8, 2008.

### FIELD OF THE INVENTION

This invention relates to a processing unit, a portable electrical device and an auto-run method thereof, and more particularly, to an auto-run operation of the portable electrical device.

### BACKGROUND OF THE INVENTION

Currently, the applied fields of electronic information products are progressively widened, and the various portable or removable electronic products are more and more popular. In an exemplar, a memory device with a universal serial bus (USB) interface has lower cost and a capability of connection with various electrical apparatus (such as a computer host), and thus becomes a convenient and portable access media. Meanwhile, more and more applications of the portable electronic products have been developed for convenience of the users.

In various applications of the portable electronic products, the most popular request is offering security protection. At present, there are two primary ways to achieve the information security protection, one of which is to use a high-level hardware to execute data encryption/decryption, and the other of which is using software to execute data encryption/decryption. By the way of using software to execute data encryption/decryption, a partial memory block would be divided from a data memory out of a micro-control unit (MCU) of a portable electrical device. By customized command, the relative control parameter and the simple encryption/decryption software from the dealer are stored within the memory block. Next, the memory block may be declared as a virtual read-only memory (ROM) device (e.g. an optical disk driver). The encryption/decryption software may be auto-run by a computer host electrically connected to the portable electrical device and thereby execute the data encryption/decryption there between.

However, by the way of using hardware to execute encryption/decryption, the portable electrical device needs to increase the amounts of chips (or integrated circuit) or electrical elements disposed within a volume-enlarged chip. This would invoke raise of product cost. By the other way of software to execute encryption/decryption, the relative control parameter and the encryption/decryption software should occupy the extra data memory of the portable electrical device and thereby reduce its memory capacity. Furthermore, when the portable electrical device has not a built-in extra memory such as USB card reader or USB hard disk drive (HDD), or the data memory of the USB flash memory device is not enough for storing the relative control parameter and the encryption/decryption software, the portable electrical device can not perform an auto-run function.

### SUMMARY OF THE INVENTION

Therefore, an aspect of the present invention is to provide a processing unit, a portable electrical device and an auto-run method thereof, which provide an auto-run function and prevent the data memory capacity from being occupied.

Another aspect of the present invention is to provide a processing unit, a portable electrical device and an auto-run method thereof, which use program codes to declare a virtual memory device and thereby save the data memory capacity and prevent IC cost from being increased.

Another aspect of the present invention is to provide a processing unit, a portable electrical device and an auto-run method thereof, which provide data security protection or other functions for the portable electrical device.

According to one embodiment of the present invention, the processing unit used for a portable electrical device configured to be electrically connected to an electronic apparatus. The processing unit comprises a kernel program memory area, a virtual memory device and a virtual auto-run file. The kernel program memory area is configured to store at least one program code. The virtual memory device is established within the kernel program memory area. The virtual auto-run file is stored in the virtual memory device. When the portable electrical device is electrically connected to the electronic apparatus, the electronic apparatus automatically executes at least one predetermined operation on the portable electrical device according to the virtual auto-run file.

According to another embodiment of the present invention, the above-mentioned portable electrical device includes a first connecting interface configured to be electrically connected to the electronic apparatus.

According to another embodiment of the present invention, the portable electrical device comprises a processing unit and a kernel program memory area established within the processing unit. An auto-run method for the portable electrical device comprises the following steps of:

using a portion of the program stored in the kernel program memory area to establish a virtual memory device in the kernel program memory area, and storing a virtual auto-run file in the virtual memory device; and

when the portable electrical device is electrically connected to the electronic apparatus, using the electronic apparatus to identify the virtual memory device and automatically execute at least one predetermined operation on the portable electrical device according to the virtual auto-run file.

Therefore, with utilization of the processing unit, the portable electrical device and auto-run method thereof disclosed in the embodiments of the present invention, the portable electrical device can be auto-run and thereby save the data memory capacity. Even though the portable electrical device does not own memory, the portable electrical device still can be auto-run and provides data security protection or other functions.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a portable electrical device according to a first embodiment of the present invention;

FIG. 2 shows a processing unit according to the first embodiment of the present invention;

FIG. 3 shows a portable electrical device according to a second embodiment of the present invention;

FIG. 4 shows an application of the portable electrical device according to FIG. 1; and

FIG. 5 is a flow diagram showing an auto-run method of the portable electrical device according to a preferred embodiment of the present invention.

### DETAILED DESCRIPTION OF THE PREFERRED EMBODIMENT

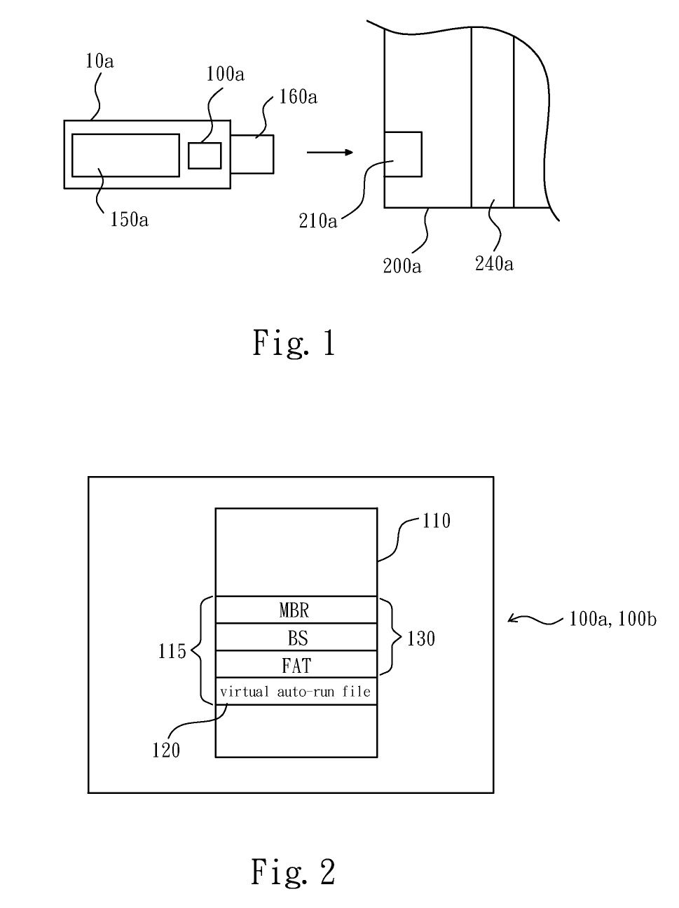

In order to make the illustration of the present invention more explicit and complete, the following description is stated with reference to FIG. 1 through FIG. 5.

Referring to FIG. 1, a portable electrical device 10a according to a first embodiment of the present invention is presented herein, which is being electrically connected to an electronic apparatus 200a.

Returning to FIG. 1, the portable electrical device 10a may be a memory device, such as a USB flash driver, a USB HDD, a USB memory device, a personal digital assistant (PDA), a memory card, a flash memory, a micro drive or a digital camera. The portable electrical device 10a comprises a processing unit 100a, a data memory 150a and a first connecting interface 160a. The data memory 150a is configured to store data. The first connecting interface 160a may be USB, PCMCIA, RS232, printing port, IEEE 1394, IrDA, IDE, ATAPI, SCSI, PCI, ePCI, ISA or any one of wireless communication modules for being electrically connected to the electronic apparatus 200a.

Referring to FIG. 2, the processing unit 100a according to the first embodiment of the present invention is presented herein. The processing unit 100a may be a micro-processor, a micro-control unit (MCU), a central processing unit (CPU) or a system-on-chip (SoC) and is configured to process, control, store data, execute commands or program for the portable electrical device 10a. The processing unit 100a comprises a kernel program memory area 110, a virtual memory device 115, a virtual auto-run file 120 and a plurality of file system parameters 130. The kernel program memory area 110 is configured to store at least one kernel or core program code, wherein a portion of the stored program code is configured to declare that the virtual memory device 115 (such as a virtual read-only memory device) is established in the kernel program memory area 110, and the virtual auto-run file 120 and the file system parameters 130 can be stored in the virtual memory device 115. In the present embodiment, the virtual auto-run file 120 may be implemented with a virtual “autorun.inf” file, such as an executable file or a batch file, which records a plurality of commands. A portion of command is used to predefine that when the portable electrical device 10a is electrically connected to the electronic apparatus 200a, at least one predetermined operation (illustrated in following FIG. 4) on the processing unit 100a is automatically performed. In the present embodiment, the file system parameters 130 are some relative parameters of a file system, such as master boot recorders (MBR), boot sectors (BS) and file allocation tables (FAT).

Returning to FIG. 1, the electronic apparatus 200a of the present embodiment may be a host system with an operation system (OS) 240a, such as a desktop computer, a notebook computer (or laptop computer), a smart-phone, a server, a PDA, a digital camera system, a digital media adaptor (DMA) or other electronic apparatus connectible to the portable electrical device 10a. The operation system 240a may be any common operation system, such as WINDOWS operation system provided by Microsoft Corp. By using the virtual memory device 115 of the processing unit 100a, the operation system 240a of the electronic apparatus 200a can regard the portable electrical device 10a as a fixed storage device and readily identify the virtual memory device 115 from the portable electrical device 10a so as to read out the file system parameters 130 stored therein and execute the predetermined operation predefined within the virtual auto-run file 120. Furthermore, the electronic apparatus 200a includes at least one first connecting interface 210a configured to be electrically connected the first connecting interface 160a of the portable electrical device 10a.

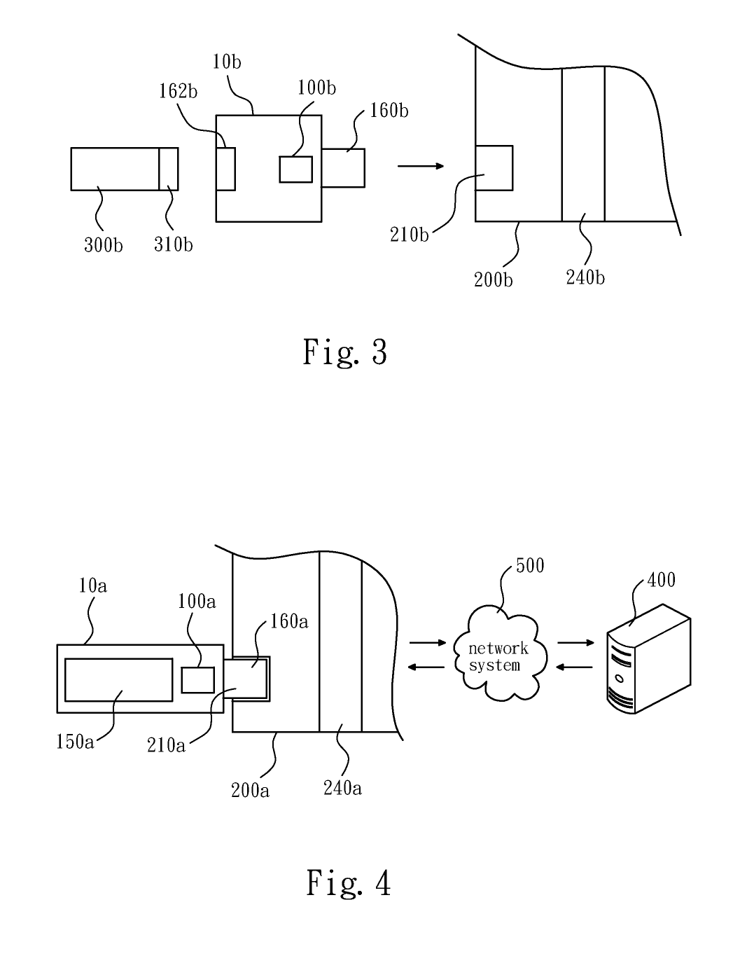

Referring to FIG. 3, a portable electrical device 10b according to a second embodiment of the present invention is presented herein, which may be implemented with a memory read/write device, such as a USB flash card reader, USB HDD, or memory card. Since the portable electrical device 10b does not own enough data memory, the portable electrical device 10b may merely channel data read/write between a memory device 300b and electronic apparatus 200b. The electronic apparatus 200b of the second embodiment is similar to the electronic apparatus 200a of the first embodiment. The portable electrical device 10b comprises a processing unit 100b, a first connecting interface 160b and a second connecting interface 162b, wherein the first connecting interface 160b is configured to be electrically connected to the first connecting interface 210b of the electronic apparatus 200b, and the second connecting interface 162b is configured to be electrically connected to a second connecting interface 310b of the memory device 300b. The first connecting interface 160b and the second connecting interface 162b may be USB, PCMCIA, RS232, printing port, IEEE 1394, IrDA, IDE, ATAPI, SCSI, PCI, ePCI, ISA or any other wireless communication module. When the memory device 300b is electrically connected to the portable electrical device 10b and the portable electrical device 10b is further electrically connected to the electronic apparatus 200b, the electronic apparatus 200b can regard the portable electrical device 10b as a fixed storage device and identify the virtual memory device 115 from the portable electrical device 10b so as to read out the file system parameters 130 and the virtual auto-run file 120 stored therein. Next, the operation system 240b of the electronic apparatus 200b can automatically executes at least one predetermined operation on the portable electrical device 10b, according to the definition of the virtual auto-run file 120, for an example that the predetermined operation may define a control operation of reading/writing data from the memory device 300b. Therefore, when the portable electrical device 10b does not own enough data memory for storing application program, the portable electrical device 10b can use the auto-run function provided by the processing unit 100b to perform an auto-run operation.

Referring to FIG. 2 and FIG. 4, the portable electrical device 10a of FIG. 1 is exemplified for illustration herein. When the portable electrical device 10a is electrically connected to the electronic apparatus 200a, the operation system 240a of the electronic apparatus 200a can identify the virtual memory device 115 from the portable electrical device 10a to read out the file system parameters 130 and the virtual auto-run file 120 stored within the virtual memory device 115. Next, the electronic apparatus 200a can automatically executes at least one predetermined operation on the portable electrical device 10a according to definition of the virtual auto-run file 120. For example, the predetermined operation defined by the virtual auto-run file 120 may comprises the following steps of: after auto-running the portable electrical device 10a, executing a network browser on the electronic apparatus 200a to be connected to a remote external system 400 (such as a network server) through a network system 500 (such as internet), wherein the external system 400 may store an encryption/decryption application program (AP) or other function application programs; and next, automatically downloading the encryption/decryption application program to the electronic apparatus 200a and then executing the encryption/decryption application program to perform encryption/decryption protection for data transmitted between the portable electrical device 10a and the electronic apparatus 200a. Since the application program is provided by the external system 400 connected to the electronic apparatus 200a, it does not affect the memory capacity of the portable electrical device 10a. Even the portable electrical device 10a does not own extra memory and can still download the application program to execute data encryption/decryption protection or other added functions by the predetermined operation of the processing unit 100a.

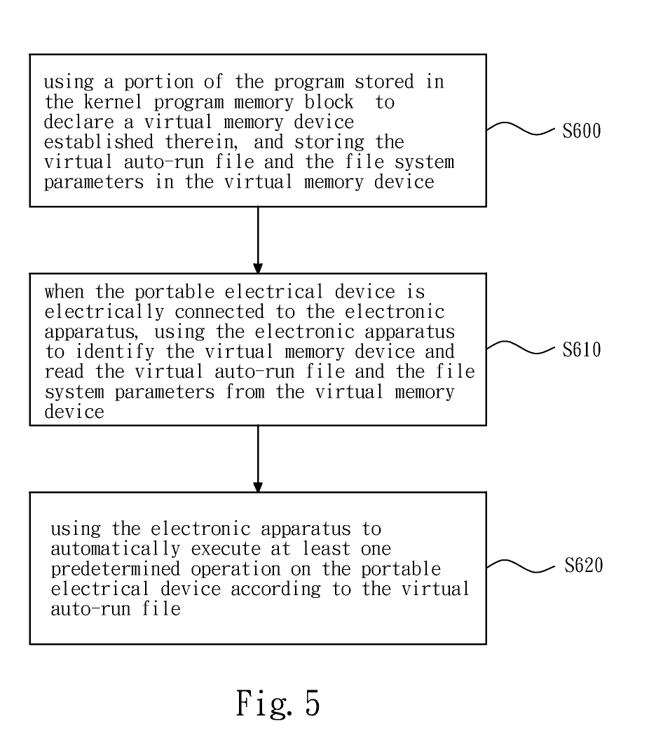

Referring to FIG. 5, an auto-run method of the processing unit 100a according to the preferred embodiment of the present invention is presented herein and illustrated in detail with accompanying of FIGS. 1 and 2. The method comprises the following steps of:

Step S600, using a portion of the program code stored within the kernel program memory area 110 to declare a virtual memory device 115 established in the kernel program memory area 110, and storing a virtual auto-run file 120 and the file system parameters 130 in the virtual memory device 115;

Step S610, when the first connecting interface 160a of the portable electrical device 10a is electrically connected to the first connecting interface 210a of the electronic apparatus 200a, using the operation system 240a of the electronic apparatus 200a to identify the virtual memory device 115 and read the virtual auto-run file 120 and the file system parameters 130 from the virtual memory device 115; and

Step S620, using the electronic apparatus 200a to automatically execute at least one predetermined operation on the portable electrical device 10a according to the virtual auto-run file 120. For example, the predetermined operation may comprises the following steps of: downloading the encryption/decryption program from a remote external system 400 through the network system 500; and executing the encryption/decryption program to perform encryption/decryption protection for data transmitted between the portable electrical device 10a and the electronic apparatus 200a.

In conclusion, the processing unit, the portable electrical device and the auto-run method thereof can provide an auto-run function and thereby save the data memory capacity. The portable electrical device can be auto-run even though it does not own memory. Since the virtual memory device of the processing unit is declared as a virtual read-only memory device by using the program code which occupies less memory space, the program memory capacity thereof needs not to be enlarged and thereby prevent IC cost from being increased. Furthermore, the processing unit and the portable electrical device of the present invention can be connected to the external system to download AP and thereby achieve data security protection or other added functions.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A processing unit for using in a portable electrical device configured to be electrically connected to an electronic apparatus, and the processing unit comprising:
a kernel program memory area configured to store at least one program;
a virtual memory device established in the kernel program memory area; and
a virtual auto-run file stored in the virtual memory device, wherein when the portable electrical device is electrically connected to the electronic apparatus, the electronic apparatus automatically executes at least one predetermined operation on the portable electrical device, according to the virtual auto-run file.

2. The processing unit as claimed in claim 1, wherein the processing unit is a micro-processor, a micro-control unit (MCU), a central processing unit (CPU) or a system-on-chip (SoC).

3. The processing unit as claimed in claim 1, wherein a portion of the program is configured to declare the virtual memory device established in the kernel program memory area.

4. The processing unit as claimed in claim 1, further comprising:
a plurality of file system parameters stored in the virtual memory device.

5. The processing unit as claimed in claim 1, wherein the file system parameters include at least one master boot recorder (MBR), boot sector (BS), file allocation table (FAT) or any combination of said parameters.

6. The processing unit as claimed in claim 1, wherein the virtual auto-run file is an executable file or a batch file configured to define the at least one predetermined operation.

7. A portable electrical device configured to be electrically connected to an electronic apparatus, comprising:
a processing unit comprising:
a kernel program memory area configured to store at least one program;
a virtual memory device established in the kernel program memory area; and
a virtual auto-run file stored in the virtual memory device;
wherein when the portable electrical device is electrically connected to the electronic apparatus, the electronic apparatus automatically executes at least one predetermined operation on the portable electrical device according to the virtual auto-run file; and
a first connecting interface configured to be electrically connected to the electronic apparatus.

8. The portable electrical device as claimed in claim 7, wherein the processing unit is a micro-processor, a micro-control unit (MCU), a central processing unit (CPU) or a system-on-chip (SoC).

9. The portable electrical device as claimed in claim 7, wherein a portion of the program is configured to declare the virtual memory device established in the kernel program memory area.

10. The portable electrical device as claimed in claim 7, wherein the processing unit further comprises a plurality of file system parameters stored in the virtual memory device.

11. The portable electrical device as claimed in claim 7, wherein the file system parameters include master boot recorder (MBR), boot sector (BS), file allocation table (FAT) or any combination of said parameters.

12. The portable electrical device as claimed in claim 7, wherein the portable electrical device is a memory reading/writing device which includes the first connecting interface configured to be electrically connected to the electronic apparatus and a second connecting interface configured to be electrically connected to a memory device.

13. The portable electrical device as claimed in claim 7, wherein the virtual auto-run file is an executable file or a batch file configured to define the at least one predetermined operation.

14. The portable electrical device as claimed in claim 7, wherein the first connecting interface is USB, PCMCIA, RS232, printing port, IEEE 1394, IrDA, IDE, ATAPI, SCSI, PCI, ePCI, ISA or any one of wireless communication modules.

15. An auto-run method of a portable electrical device, wherein the portable electrical device comprises a processing unit and a kernel program memory area established within the processing unit, and the method comprising the following steps of:
using a portion of program code stored in the kernel program memory area to establish a virtual memory device in the kernel program memory area, and storing a virtual auto-run file in the virtual memory device; and
when the portable electrical device is electrically connected to the electronic apparatus, using the electronic apparatus to identify the virtual memory device and automatically execute at least one predetermined operation on the portable electrical device according to the virtual auto-run file.

16. The auto-run method as claimed in claim 15, further comprising:
using a portion of the program code to declare the virtual memory device established in the kernel program memory area.

17. The auto-run method as claimed in claim 15, further comprising:
establishing a plurality of file system parameters in the virtual memory device.

18. The auto-run method as claimed in claim 17, wherein the electronic apparatus is a host system with an operation system configured to identify the virtual memory device of the processing unit to read the file system parameters stored in the virtual memory device and execute the virtual auto-run file.

19. The auto-run method as claimed in claim 15, wherein the at least one predetermined operation comprises:
downloading an encryption/a decryption program; and
executing the program to perform encryption/decryption protection for data transmitted between the portable electrical device and the electronic apparatus.
